(19) United States
(12) Patent Application Publication
(10) Pub. No.: US 2024/0076463 A1
(43) Pub. Date: Mar. 7, 2024

(54) IMPROVED FOAM FORMULATION

(71) Applicant: HONEYWELL INTERNATIONAL INC., Morris Plains, NJ (US)

(72) Inventors: HUIJUN-PARK YUAN, SHANGHAI (CN); BIN YU, TONAWANDA, NY (US); YIU KEUNG LING, AMHERST, NY (US); DAVID J. WILLIAMS, EAST AMHERST, NY (US)

(21) Appl. No.: 16/062,012

(22) PCT Filed: Jun. 13, 2017
(86) PCT No.: PCT/CN2017/087997

§ 371 Date: Jan. 23, 2019

(51) Int. Cl. C08J 9/00; C08G 18/16; C08G 18/18; C08G 18/22; C08G 18/42; C08G 18/76; C08J 9/12; C08J 9/14; C08K 5/521; C09D 5/02; C09D 5/18; C09D 7/63; C09D 175/06; E04B 1/80

(52) U.S. Cl. CPC C08J 9/0038; C08G 18/163; C08G 18/1816; C08G 18/225; C08G 18/42; C08G 18/7671; C08J 9/125; C08J 9/127; C08J 9/144; C08K 5/521; C09D 5/021; C09D 5/18; C09D 7/63; C09D 175/06; E04B 1/80; C08J 2201/022; C08J 2203/10; C08J 2203/162; C08J 2203/182; C08J 2375/06

(57) ABSTRACT

Disclosed is a method of reducing the lambda aging of a polyurethane foam, a polyisocyanurate foam or a mixture thereof comprising producing the foam from a foamable composition comprising an isocyanate and a polyol premix composition comprising a polyol or mixture of polyols, a blowing agent selected from the group consisting of 1,3,3,3-tetrafluoropropene (1234ze), 1,1,1,4,4,4-hexafluorobut-2-ene (1336mzzm) and/or 1-chloro-3,3,3-trifluoropropene (1233zd) and a flame retardant wherein the flame retardant comprises 25 phpp or less of a phosphate based flame retardant.

### FIELD

The present invention relates to the provision of a polyurethane foam, a polyisocyanurate foam or a mixture thereof which exhibits reduced lambda aging over time, and to foamable compositions and foaming methods for making same.

### BACKGROUND

The use of insulation boards made from polyisocyanurate (PIR) or polyurethane (PU) foams as a building envelope or cladding in commercial, residential and industrial buildings is well established in the art. The use of polyisocyanurate (PIR) or polyurethane (PU) foams allows the production of boards with excellent thermal conductivity enabling their use to provide thermal insulation for buildings. In addition, the foam cores of such boards are low in density, have excellent fire resistance properties and have a high strength to weight ratio.

Polyurethane foams are produced by reacting a polyisocyanate with one or more polyols in the presence of one or more blowing agents, one or more catalysts, one or more surfactants and optionally other ingredients. In the case of polyisocyanurate foam, the foam is formed by the reaction of polyisocyanate with itself to form a cyclic trimer structure. In practice, foams commonly described as polyisocyanurate contain both polyurethane and polyisocyanurate structures and foams described as polyurethane often incorporate some polyisocyanurate structures. Thus, the present application relates to polyurethane foams, to polyisocyanurate foams and to mixtures thereof. The blowing agent can be a physical blowing agent or a chemical blowing agent. Physical blowing agents create bubbles in the liquid mixture by volatilizing and expanding due to the heat generated when the polyisocyanate reacts with the polyol, forming bubbles therein. In the case of chemical blowing agents, also known as gas generating materials, gaseous species are generated by thermal decomposition or reaction with one or more of the ingredients used to produce the polyurethane and/or polyisocyanurate foam. As the polymerization reaction proceeds, the liquid mixture becomes a cellular solid, entrapping the blowing agent in the cells of the foam.

It has been common to use liquid fluorocarbon blowing agents because of their ease of use, among other factors. Fluorocarbons not only act as physical blowing agents by virtue of their volatility, but also are encapsulated or entrained in the closed cell structure of the rigid foam and are generally the major contributor to the thermal conductivity properties of the foams. After the foam is formed, the k-factor or lambda associated with the foam produced provides a measure of the ability of the foam to resist the transfer of heat through the foam material. A foam produced having a lower k-factor is more resistant to heat transfer and therefore a better foam for insulation purposes. Thus, the production of lower k-factor foams is generally desirable and advantageous.

In recent years, concern over climate change has driven the development of a new generation of fluorocarbons, which meet the requirements of both ozone depletion and climate change regulations. Among these are certain hydrohaloolefins including certain hydrofluoroolefins of which 1,3,3,3-tetrafluoropropene (1234ze) and 1,1,1,4,4,4-hexafluorobut-2-ene (1336mzzm) are of particular interest and hydrochlorofluoroolefins of which 1-chloro-3,3,3-trifluoropropene (1233zd) is of particular interest. Processes for the manufacture of trans-1,3,3,3-tetrafluoropropene are disclosed in U.S. Pat. Nos. 7,230,146 and 7,189,884. Processes for the manufacture of trans-1-chloro-3,3,3-trifluoropropene are disclosed in U.S. Pat. Nos. 6,844,475 and 6,403,847.

A polyisocyanurate (PIR) or polyurethane (PU) foam insulation board may be in situ as part of a building for a long period of time. As the K-factor (or lambda) of a foam is primarily determined by the thermal insulation properties of the blowing agent entrapped in the cells of the foam, any variation in the composition of the blowing agent will affect the average lambda value of the foam over time. Estimates of the average thermal conductivity (lambda value or k-factor) over a period of 25 years of use under operational conditions can be made using European standard EN13165 (2010) for factory made rigid polyurethane and polyisocyanurate foam products used as thermal insulation boards for buildings and European Standard EN14315 (2013) for in-situ formed sprayed rigid polyurethane and polyisocyanurate foam products (both of which are incorporated by reference)

Thus, there is a desire in the art for a method of preventing such variations in the composition of the blowing agent overtime and thereby preventing a dterioration in the thermal conductivity of the insulation board. This desire in the art is addressed by the present invention as set out below.

### SUMMARY

The first aspect of the invention relates to a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent selected from the group consisting of 1,3,3,3-tetrafluoropropene (1234ze), 1,1,1,4,4,4-hexafluorobut-2-ene (1336mzzm) and/or 1-chloro-3,3,3-trifluoropropene (1233zd) and a flame retardant wherein the flame retardant comprises 25 phpp or less of a phosphate based flame retardant.

The term phpp defines the amount of flame retardant as “parts per hundred parts of polyol” by weight.

### DETAILED DESCRIPTION

Flame retardants are added to foam insulation boards to inhibit or delay the spread of fire by suppressing the chemical reactions in the flame or by forming a protective char layer on the surface of a material. Generally, flame retardants are added to the polyol premix composition as a liquid or solid. The flame retardants can alternatively be added with the isocyanurate or can be added as a separate stream prior to forming the foam. Generally flame retardants can be mineral based, organohalogen compounds or organophosphorus compounds. Conventional flame retardants used in foam insulation boards include tris(2-chloroethyl)phosphate, tris(2-chloropropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl) aminomethylphosphonate, dimethyl methylphosphonate, tri(1,3-dichloropropyl)phosphate, and tetra-kis-(2-chloroethyl)ethylene diphosphate, triethylphosphate, ammonium phosphate, various halogenated aromatic compounds, aluminum trihydrate, diethyl-N, N-bis (2-hydroxyethyl) aminomethylphosphonate (Fyrol 6) and melamine.

For the purposes of this invention, the phosphate based flame retardants are selected from the group consisting of tris(2-chloroethyl)phosphate, tris(2-chloropropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl) aminomethylphosphonate, dimethyl methylphosphonate, tri(1,3-dichloropropyl)phosphate, diethyl-N, N-bis (2-hydroxyethyl) aminomethylphosphonate (Fyrol 6) tetra-kis-(2-chloroethyl)ethylene diphosphate, triethylphosphate and ammonium phosphate, more preferably tris(1-chloro-2-propyl) phosphate (TCPP), triethylphosphate (TEP) and diethyl-N, N-bis (2-hydroxyethyl) aminomethylphosphonate (Fyrol 6).

The amount of the phosphate based flame retardant in the polyol premix composition is 25 phpp or less, preferably 20 phpp or less, preferably 15 phpp or less, preferably 10 phpp or less, preferably 5 phpp or less. Preferably, the foamable composition does not contain a phosphate based flame retardant.

The flame retardants can be blended with the polyols and therefore provided in the polyol premix composition with the polyol or mixture of polyols, prior to the production of the foamable composition. Alternatively, the flame retardants can be added as a separate stream during the formation of the foamable composition. For the purposes of this invention, the amount of phosphate based flame retardant includes all phosphate-based flame retardant, i.e. the amount of phosphate based flame retardant present in the polyol premix composition or added as a separate stream during the formation of the foamable composition.

The inventors have unexpectedly found that by limiting the amount of the phosphate based flame retardant in the polyol premix composition to 25 phpp or less, it is possible to reduce the lambda aging of a polyurethane foam, a polyisocyanurate foam or a mixture thereof produced from the polyol premix composition after 21 days aging at 70° C. Thus, in a particularly preferred feature of the first aspect, the polyurethane foam, polyisocyanurate foam or mixture thereof has a lambda change after 21 days aging at 70° C. of 6 mW/mK or less.

Annex C of EN13165 (2010) and EN14315 (2013) set out a “normality test” (see sections C.2 and C.3 of EN13165 (2010) and EN14315 (2013)) and an optional “accelerated test” (see C.4.4). For the purposes of this invention, estimation of the average lambda value can be made using the “normality test” set out in sections C.2 and C.3 of EN13165 (2010) and EN14315 (2013), depending on the foam type, preferably the estimation of the average lambda value is made using the “normality test” set out in sections C.2 and C.3 of EN13165 (2010) and EN14315 (2013), depending on the foam type.

In a preferred feature of the first aspect, the reduction of lambda aging of the foam can be measured by using the “normality test” as set out in the example section and in sections C.2 and C.3 of EN13165 (2010) for all foams except spray foams, or as measured by sections C.2 and C.3 of EN14315 (2013). Thus, the polyurethane foam, polyisocyanurate foam or mixture thereof has a reduction in lambda aging after 21 days aging at 70° C. as measured using the “normality test” as set out in the example section and in sections C.2 and C.3 of EN13165 (2010) for all foams except spray foams, or as measured by sections C.2 and C.3 of EN14315 (2013). Preferably, the polyurethane foam, polyisocyanurate foam or mixture thereof has a lambda change after 21 days aging at 70° C. of 6 mW/mK or less as measured using the “normality test” as set out in the example section and in sections C.2 and C.3 of EN13165 (2010) for all foams except spray foams, or as measured by sections C.2 and C.3 of EN14315 (2013).

The inventors have found that the foam produced using the method of the first aspect shows improved properties of lambda change and flame retardancy, when the amount of phosphate based flame retardant in the polyol premix composition is preferably 15 phpp or less. Thus, the first aspect provides a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent selected from the group consisting of 1,3,3,3-tetrafluoropropene (1234ze), 1,1,1,4,4,4-hexafluorobut-2-ene (1336mzzm) and/or 1-chloro-3,3,3-trifluoropropene (1233zd) and a flame retardant wherein the phosphate based flame retardant comprises 15 phpp or less of a flame retardant.

As set out above, phosphate based flame retardants are only one class of flame retardants. The inventors have determined that the polyol premix composition may additionally comprise a brominated reactive flame retardant, particularly a brominated polyol compound in combination with the phosphate based flame retardant. The amount of brominated flame retardant required to obtain the necessary flame retardancy, can be determined by the skilled person using their common general knowledge, as the presence of the brominated flame retardant does not affect the lambda ageing of the foam produced from the polyol premix.

Examples of such brominated reactive flame retardants include reactive flame retardant of Saytex RB-79 (a hydroxy terminated ester of tetrabromophthalic anhydride with diethylene glycol and propylene glycol) or Saytex RB-9170.

For the purposes of this invention, the blowing agent comprises at least one or a combination of a hydrohaloolefin blowing agent selected from 1,3,3,3-tetrafluoropropene (1234ze), 1,1,1,4,4,4-hexafluorobut-2-ene (1336mzzm) and/or 1-chloro-3,3,3-trifluoropropene (1233zd). 1,3,3,3-Tetrafluoropropene (1234ze) can be provided as the cis isomer, the trans isomer or a combination thereof. Preferably, 1,3,3,3-tetrafluoropropene is provided as the trans isomer. 1-chloro-3,3,3-trifluoropropene (1233zd) can be provided as the cis isomer, the trans isomer or a combination thereof. Preferably, 1-chloro-3,3,3-trifluoropropene is provided as the trans isomer. 1,1,1,4,4,4-Hexafluorobut-2-ene (1336mzzm) can be provided as the cis isomer, the trans isomer or a combination thereof. Preferably, 1,1,1,4,4,4-hexafluorobut-2-ene is provided as the cis isomer.

Thus, the blowing agent preferably comprises at least one or a combination of trans 1,3,3,3-tetrafluoropropene (trans 1234ze), cis 1,1,1,4,4,4-hexafluorobut-2-ene (cis 1336mzzm) and/or trans 1-chloro-3,3,3-trifluoropropene (trans 1233zd). The blowing agent preferably comprises cis 1,1,1,4,4,4-hexafluorobut-2-ene (cis 1336mzzm) and/or trans 1-chloro-3,3,3-trifluoropropene (trans 1233zd). The blowing agent most preferably comprises trans 1-chloro-3,3,3-trifluoropropene (trans 1233zd).

The blowing agents may comprise, consist essentially of, or consist of 1,3,3,3-tetrafluoropropene (1234ze), 1,1,1,4,4,4-hexafluorobut-2-ene (1336mzzm) and/or 1-chloro-3,3,3-trifluoropropene (1233zd), preferably trans 1,3,3,3-tetrafluoropropene (trans 1234ze) cis 1,1,1,4,4,4-hexafluorobut-2-ene (cis 1336mzzm) and/or trans 1-chloro-3,3,3-trifluoropropene (trans 1233zd).

Thus, the first aspect of the invention particularly relates to a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent comprising trans 1-chloro-3,3,3-trifluoropropene (trans 1233zd) and a flame retardant wherein the flame retardant comprises 25 phpp or less of a phosphate based flame retardant. Preferably, the first aspect of the invention particularly relates to a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent comprising trans 1-chloro-3,3,3-trifluoropropene (trans 1233zd) and a flame retardant wherein the flame retardant comprises 15 phpp or less of a phosphate based flame retardant.

The blowing agent may additionally comprise one or more additional co-blowing agents, such as a hydrocarbon, fluorocarbon, chlorocarbon, fluorochlorocarbon, hydrochlorofluorocarbon, hydrofluorocarbon, halogenated hydrocarbon, ether, fluorinated ether, ester, acetal, alcohol, aldehyde, ketone, organic acid, gas generating material, water, carbon dioxide (CO₂), or combinations thereof. Preferred blowing agents have a Global Warming Potential (GWP) of not greater than 150, more preferably not greater than 100 and even more preferably not greater than 75. As used herein, “GWP” is measured relative to that of carbon dioxide and over a 100-year time horizon, as defined in “The Scientific Assessment of Ozone Depletion, 2002, a report of the World Meteorological Association's Global Ozone Research and Monitoring Project,” which is incorporated herein by reference. Preferred blowing agents have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

Preferred optional co-blowing agents include water, organic acids that produce CO₂ and/or CO; CO₂, ethers, halogenated ethers; esters, alcohols, aldehydes, ketones; trans-1,2 dichloroethylene; methylal, methyl formate; hydrofluorocarbons, such as 1,1,1,2-tetrafluoroethane (134a); 1,1,2,2-tetrafluoroethane (134); 1,1,1,3,3-pentafluorobutane (365mfc); 1,1,1,2,3,3,3-heptafluoropropane (227ea), 1,1,1,3,3,3-hexafluoropropane (236fa); 1,1,1,2,3,3-hexafluoropropane (236ea); 1,1,1,2,3,3,3-heptafluoropropane (227ea), 1,1-difluoroethane (152a); 1,1,1,3,3-pentafluoropropane (245fa); hydrocarbons such as butane; isobutane; normal pentane; isopentane; cyclopentane, or combinations thereof.

More preferably, the co-blowing agents are one or more selected from water, organic acids that produce CO₂ and/or CO, trans-1,2 dichloroethylene; methylal, methyl formate; 1,1,1,2-tetrafluoroethane (134a); 1,1,1,3,3-pentafluorobutane (365mfc); 1,1,1,2,3,3,3-heptafluoropropane (227ea), 1,1-difluoroethane (152a); 1,1,1,3,3-pentafluoropropane (245fa); butane; isobutane; normal pentane; isopentane; cyclopentane, or combinations thereof.

Thus, the first aspect of the invention particularly relates to a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent comprising trans 1-chloro-3,3,3-trifluoropropene (trans 1233zd) and one or more co-blowing agents selected from water, organic acids that produce CO₂ and/or CO, trans-1,2 dichloroethylene; methylal, methyl formate; 1,1,1,2-tetrafluoroethane (134a); 1,1,1,3,3-pentafluorobutane (365mfc); 1,1,1,2,3,3,3-heptafluoropropane (227ea), 1,1-difluoroethane (152a); 1,1,1,3,3-pentafluoropropane (245fa); butane; isobutane; normal pentane; isopentane; cyclopentane, or combinations thereof, and a flame retardant wherein the flame retardant comprises 25 phpp or less of a phosphate based flame retardant.

Preferably, the first aspect of the invention particularly relates to a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent comprising trans 1-chloro-3,3,3-trifluoropropene (trans 1233zd) and one or more co-blowing agents selected from water, organic acids that produce CO₂ and/or CO, trans-1,2 dichloroethylene; methylal, methyl formate; 1,1,1,2-tetrafluoroethane (134a); 1,1,1,3,3-pentafluorobutane (365mfc); 1,1,1,2,3,3,3-heptafluoropropane (227ea), 1,1-difluoroethane (152a); 1,1,1,3,3-pentafluoropropane (245fa); butane; isobutane; normal pentane; isopentane; cyclopentane, or combinations thereof, and a flame retardant wherein the flame retardant comprises 15 phpp or less of a phosphate based flame retardant.

The co-blowing agent(s) particularly include one or a combination of water and/or normal pentane, isopentane or cyclopentane, which may be provided with one or a combination of the hydrohaloolefin blowing agents discussed herein, particularly in combination with trans 1-chloro-3,3,3-trifluoropropene (trans 1233zd).

The blowing agent particularly comprises 1,3,3,3-tetrafluoropropene (1234ze), 1,1,1,4,4,4-hexafluorobut-2-ene (1336mzzm) and/or 1-chloro-3,3,3-trifluoropropene (1233zd), preferably trans 1,3,3,3-tetrafluoropropene (trans 1234ze) cis 1,1,1,4,4,4-hexafluorobut-2-ene (cis 1336mzzm) and/or trans 1-chloro-3,3,3-trifluoropropene (trans 1233zd) in combination with water. In particular, the blowing agent comprises, consists essentially of or consists of trans 1-chloro-3,3,3-trifluoropropene (trans 1233zd) and water.

Thus, the first aspect of the invention particularly relates to a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent comprising trans 1-chloro-3,3,3-trifluoropropene (trans 1233zd) and water, and a flame retardant wherein the flame retardant comprises 25 phpp or less of a phosphate based flame retardant.

Preferably, the first aspect of the invention particularly relates to a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent comprising trans 1-chloro-3,3,3-trifluoropropene (trans 1233zd) and water, and a flame retardant wherein the flame retardant comprises 15 phpp or less of a phosphate based flame retardant.

More preferably, the blowing agent consists essentially of trans 1-chloro-3,3,3-trifluoropropene (trans 1233zd) and water.

The blowing agent component (that is a hydrohaloolefin and optionally a co-blowing agent) is preferably present in the polyol premix composition in an amount of from about 1 wt. % to about 30 wt. %, preferably from about 3 wt. % to about 25 wt. %, and more preferably from about 5 wt. % to about 25 wt. %, by weight of the polyol premix composition.

When both a hydrohaloolefin and an optional blowing agent are present, the hydrohaloolefin component is preferably present in the blowing agent in an amount of from about 5 wt. % to about 99 wt. %, preferably from about 7 wt. % to about 98 wt. %, and more preferably from about 10 wt. % to about 95 wt. %, by weight of the blowing agents; and the optional blowing agent is preferably present in the blowing agent in an amount of from about 95 wt. % to about 1 wt. %, preferably from about 93 wt. % to about 2 wt. %, and more preferably from about 90 wt. % to about 5 wt. %, by weight of the blowing agent.

The polyol premix composition comprises a polyol or a mixture of polyols. The polyol or mixture of polyols can be any polyol or polyol mixture which reacts in a known fashion with an isocyanate in preparing a polyurethane foam, a polyisocyanurate foam or a mixture thereof. Useful polyols comprise one or more of a sucrose containing polyol; phenol, a phenol formaldehyde containing polyol; a glucose containing polyol; a sorbitol containing polyol; a methylglucoside containing polyol; an aromatic polyester polyol; glycerol; ethylene glycol; diethylene glycol; propylene glycol; one or more of (a) condensed with one or more of (b), wherein (a) is selected from glycerine, ethylene glycol, diethylene glycol, trimethylolpropane, ethylene diamine, pentaerythritol, soy oil, lecithin, tall oil, palm oil, and castor oil; and (b) is selected from ethylene oxide, propylene oxide, a mixture of ethylene oxide and propylene oxide; and combinations thereof.

The polyol or mixture of polyols is usually present in the polyol premix composition in an amount of from about 50 wt. % to about 95 wt. %, preferably from about 50 wt. % to about 85 wt. %, and more preferably from about 55 wt. % to about 80 wt. %, by weight of the polyol premix composition.

The polyol premix composition may also include one or more additional materials selected from a silicone surfactant, a non-silicone surfactant, a metal catalyst, an amine catalyst and combinations thereof as set out in detail below.

The polyol premix composition may comprise a surfactant, preferably a silicone surfactant. The silicone surfactant preferably aids in the formation of a foam, as well as to control the size of the bubbles of the foam so that a foam of a desired cell structure is obtained. Preferably, a foam with small bubbles or cells therein of uniform size is desired since it has the most desirable physical properties such as compressive strength and thermal conductivity. Also, it is critical to have a foam with stable cells which do not collapse prior to forming or during foam rise. It is further desirable to have cells which are “closed”, that is the walls of the cells are intact and are not open to the atmosphere allowing for ready exchange of the gases in the cell with atmospheric gases.

Silicone surfactants for use in the preparation of polyurethane and/or polyisocyanurate foams are available under a number of trade names known to those skilled in this art. Such materials have been found to be applicable over a wide range of formulations allowing uniform cell formation and maximum gas entrapment to achieve very low density foam structures. The preferred silicone surfactant comprises a polysiloxane polyoxyalkylene block co-polymer. Some representative silicone surfactants useful for this invention are Momentive's L-5130, L-5180, L-5340, L-5440, L-6100, L6124, L-6900, L-6980, L-6988, and Y10762; Air Products (now Evonik) Dabco193, Dabco 197, Dabco 5582, Dabco 5598, Dabco SI 3504, and Dabco SI 3102and B-8404, B-8407, B-8409 B84205 B84210, B84501, B-8462, B8465, B84701, B84704, B8490, and B8496 from Evonik Industries AG of Essen, Germany. Others are disclosed in U.S. Pat. Nos. 2,834,748; 2,917,480; 2,846,458 and 4,147,847, which are incorporated herein by reference.

The silicone surfactant component is usually present in the polyol premix composition in an amount of from about 0.5 wt. % to about 5.0 wt. %, preferably from about 1.0 wt. % to about 4.0 wt. %, and more preferably from about 1 wt. % to about 3.0 wt. %, by weight of the polyol premix composition

The polyol premix composition may optionally contain a non-silicone surfactant, such as a non-silicone, non-ionic surfactant. Such may include oxyethylated alkylphenols, oxyethylated fatty alcohols, paraffin oils, castor oil esters, ricinoleic acid esters, turkey red oil, groundnut oil, paraffins, and fatty alcohols. A preferred non-silicone non-ionic surfactant is LK-443 which is commercially available from Air Products Corporation or Vorasurf 504 from DOW.

When a non-silicone, non-ionic surfactant used, it is usually present in the polyol premix composition in an amount of from about 0.25 wt. % to about 3.0 wt. %, preferably from about 0.5 wt. % to about 2.5 wt. %, and more preferably from about 0.75 wt. % to about 2.0 wt. %, by weight of the polyol premix composition.

The polyol premix composition further comprises one or more catalysts, in particular amine catalysts and/or metal catalysts. Amine catalysts may include, but are not limited to, primary amine, secondary amine or tertiary amine. Useful tertiary amine catalysts non-exclusively include N,N-dimethylcyclohexylamine, N,N-dimethylethanolamine, dimethylaminoethoxyethanol, N,N,N′-trimethylaminoethyl-ethanolamine, N,N,N′-trimethyl-N′-hydroxyethylbisaminoethylether, tetramethyliminobispropylamine, 2-[[2-[2-(dimethylamino)ethoxy]ethyl] methylamino] ethanol, pentamethyldiethylene-triamine, pentamethyldipropylenetriamine, N,N,N′,N″,N″-pentamethyl-dipropylenetriamine, 1,1,4,7,10,10-hexamethyltriethylenetetramine, N,N-bis(3-dimethylaminopropyl)-N-isopropanolamine, N′-(3-(dimethylamino) propyl)-N,N-dimethyl-1,3-propanediamine, bis(3-dimethylaminopropyl)-n, n-dimethylpropanediamine, bis-(2-dimethylaminoethyl)ether, N,N′,N″-dimethylaminopropylhexahydrotriazine, tetramethyliminobispropylamine, trimethyl-n′,2-hydroxyethyl-propylenediamine, Bis-(3-aminopropyl)-methylamine, N,N-dimethyl-1,3-propanediamine, 1-(dimethylamino)hexadecane, benzyldimethylamine, 3-dimethylaminopropyl urea, dicyclohexylmethylamine; ethyldiisopropylamine; dimethylisopropylamine; methylisopropylbenzylamine; methylcyclopentylbenzylamine; isopropyl-sec-butyl-trifluoroethylamine; diethyl-(a-phenylethyl)amine, tri-n-propylamine, or combinations thereof. Useful secondary amine catalysts non-exclusively include dicyclohexylamine; t-butylisopropylamine; di-t-butylamine; cyclohexyl-t-butylamine; di-sec-butylamine, dicyclopentylamine; di-(α-trifluoromethylethyl)amine; di-(α-phenylethyl)amine; or combinations thereof.

Other useful amines include morpholines, imidazoles and ether containing compounds. These include
dimorpholinodiethylether
N-ethylmorpholine
N-methylmorpholine
bis(dimethylaminoethyl) ether
imidizole
n-methylimidazole
1,2-dimethylimidazole
dimorpholinodimethylether
N,N,N′,N′,N″,N″-pentamethyldiethylenetriamine
N,N,N′,N′,N″,N″-pentaethyldiethylenetriamine
N,N,N′,N′,N″,N″-pentamethyldipropylenetriamine
bis(diethylaminoethyl) ether
bis(dimethylaminopropyl) ether.

When an amine catalyst is used, it is present in the polyol premix composition in an amount of from about 0.1 wt. % to about 8 wt. %, preferably from about 0.1 wt. % to about 7 wt. %, and more preferably from about 0.2 wt. % to about 6 wt. %, by weight of the polyol premix composition

The polyol premix composition may optionally further comprise a non-amine catalyst. Suitable non-amine catalysts may comprise an organometallic compound containing bismuth, lead, tin, titanium, antimony, uranium, cadmium, cobalt, thorium, aluminium, mercury, zinc, nickel, cerium, molybdenum, vanadium, copper, manganese, zirconium, sodium, potassium, lithium, magnesium, barium, calcium, hafnium, lanthanum, niobium, tantalum, tellunum, tungsten, cesium, or combinations thereof. Preferably, the non amine catalyst comprises an organometallic compound containing bismuth, lead, tin, zinc, sodium, potassium or combinations thereof.

The non-amine catalysts includes, bismuth 2-ethylhexonate, lead 2-ethylhexonate, lead benzoate, stannous salts of carboxylic acids, zinc salts of carboxylic acids, dialkyl tin salts of carboxylic acids (e.g., dibutyltin dilaurate, dimethyltin dineodecanoate, dioctyltin dineodecanoate, dibutyltin dilaurylmercaptide dibutyltin diisooctylmaleate dimethyltin dilaurylmercaptide dioctyltin dilaurylmercaptide, dibutyltin dithioglycolate, dioctyltin dithioglycolate), potassium acetate, potassium octoate, potassium 2-ethylhexoate, glycine salts, quaternary ammonium carboxylates, alkali metal carboxylic acid salts and tin (II) 2-ethylhexanoate or combinations thereof. The non-amine catalyst is preferably present in the polyol premix composition in an amount of from about 0.01 wt % to about 2.5 wt % preferably from about 0.02 wt % to about 2.5 wt % and more preferably from about 0.05 wt % to about 2 wt % by weight of the polyol premix composition

In the preparation of polyisocyanurate foams, trimerization catalysts can be used for the purpose of converting the blends in conjunction with excess isocyanate to polyisocyanurate-polyurethane foams. The trimerization catalysts employed can be any catalyst known to one skilled in the art, including, but not limited to, glycine salts, tertiary amine trimerization catalysts, quaternary ammonium carboxylates, and alkali metal carboxylic acid salts and mixtures of the various types of catalysts. Preferred trimerization catalysts are potassium acetate, potassium octoate, and N-(2-hydroxy-5-nonylphenol)methyl-N-methylglycinate.

Thus, the first aspect of the invention particularly relates to a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent comprising trans 1-chloro-3,3,3-trifluoropropene (trans 1233zd) and one or more co-blowing agents selected from water, organic acids that produce CO₂ and/or CO, CO₂,trans-1,2 dichloroethylene; methylal, methyl formate; 1,1,1,2-tetrafluoroethane (134a); 1,1,1,3,3-pentafluorobutane (365mfc); 1,1,1,2,3,3,3-heptafluoropropane (227ea), 1,1-difluoroethane (152a); 1,1,1,3,3-pentafluoropropane (245fa); butane; isobutane; normal pentane; isopentane; cyclopentane, or combinations thereof, a polysiloxane polyoxyalkylene block co-polymer surfactant in an amount of 0.5 wt. % to about 5.0 wt. % of the polyol premix composition, an amine catalyst in an amount of 0.1 wt. % to 8 wt. % of the polyol premix composition and/or a metal catalyst comprising an organometallic compound containing bismuth, lead, antimony, tin, zinc, potassium or combinations thereof in an amount of 0.01 wt % to 2.5 wt % of the polyol premix composition and a flame retardant wherein the flame retardant comprises 25 phpp or less of a phosphate based flame retardant.

The first aspect particularly relates to a method of reducing the lambda aging of a polyurethane foam, a polyisocyanurate foam or a mixture thereof, said method comprising producing said foam from a foamable composition comprising an isocyanate and a polyol premix composition; wherein said polyol premix composition comprises a polyol or mixture of polyols, a blowing agent comprising trans 1-chloro-3,3,3-trifluoropropene (trans 1233zd) and one or more co-blowing agents selected from water, organic acids that produce CO₂ and/or CO, CO₂ trans-1,2 dichloroethylene; methylal, methyl formate; 1,1,1,2-tetrafluoroethane (134a); 1,1,1,3,3-pentafluorobutane (365mfc); 1,1,1,2,3,3,3-heptafluoropropane (227ea), 1,1-difluoroethane (152a); 1,1,1,3,3-pentafluoropropane (245fa); butane; isobutane; normal pentane; isopentane; cyclopentane, or combinations thereof, a polysiloxane polyoxyalkylene block co-polymer surfactant in an amount of 0.5 wt. % to about 5.0 wt. % of the polyol premix composition, an amine catalyst in an amount of 0.1 wt. % to 8 wt. % of the polyol premix composition and/or a metal catalyst comprising an organometallic compound containing bismuth, lead, antimony, tin, zinc, potassium or combinations thereof in an amount of 0.01 wt % to 2.5 wt % of the polyol premix composition and a flame retardant wherein the flame retardant comprises 15 phpp or less phosphate based flame retardant.

In addition, other ingredients such as, dyes, fillers, pigments and the like can be included in the polyol premix composition. Dispersing agents and cell stabilizers can be incorporated into the polyol premix composition. Conventional fillers for use herein include, for example, aluminum silicate, calcium silicate, magnesium silicate, calcium carbonate, barium sulfate, calcium sulfate, glass fibers, carbon black and silica. The filler, if used, is normally present in an amount by weight ranging from about 5 parts to 100 parts per 100 parts of polyol. A pigment which can be used herein can be any conventional pigment such as titanium dioxide, zinc oxide, iron oxide, antimony oxide, chrome green, chrome yellow, iron blue siennas, molybdate oranges and organic pigments such as para reds, benzidine yellow, toluidine red, toners and phthalocyanines.

The polyol premix is combined with an isocyanate to form a foamable composition which is used to produce a polyurethane foam, a polyisocyanurate foam or a mixture thereof.

For the purposes of this invention, the isocyanate can be any organic polyisocyanate which can be employed in polyurethane and/or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates which are well known in the field of polyurethane chemistry. These are described in, for example, U.S. Pat. Nos. 4,868,224; 3,401,190; 3,454,606; 3,277,138; 3,492,330; 3,001,973; 3,394,164; 3,124.605; and 3,201,372, which are incorporated herein by reference. Preferred as a class are the aromatic polyisocyanates.

Representative organic polyisocyanates correspond to the formula:

R(NCO)_{z}

wherein R is a polyvalent organic radical which is either aliphatic, aralkyl, aromatic or mixtures thereof, and z is an integer which corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5-′tetraisocyanate; arylalkyl polyisocyanates such as xylylene diisocyanate; aliphatic polyisocyanate such as hexamethylene-1,6-diisocyanate, lysine diisocyanate methylester; and mixtures thereof. Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate; Typical aliphatic polyisocyanates are alkylene diisocyanates such as trimethylene diisocyanate, tetramethylene diisocyanate, and hexamethylene diisocyanate, isophorene diisocyanate, and 4,4′-methylenebis(cyclohexyl isocyanate), and the like; typical aromatic polyisocyanates include m-, and p-phenylene disocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane. Preferred polyisocyanates are the polymethylene polyphenyl isocyanates, Particularly the mixtures containing from about 30 to about 85 percent by weight of methylenebis(phenyl isocyanate) with the remainder of the mixture comprising the polymethylene polyphenyl polyisocyanates of functionality higher than 2. These polyisocyanates are prepared by conventional methods known in the art. In the present invention, the polyisocyanate and the polyol are employed in amounts which will yield an NCO/OH stoichiometric ratio in a range of from about 0.9 to about 5.0. In the present invention, the NCO/OH equivalent ratio is, preferably, about 1 or more and about 4 or less, with the ideal range being from about 1.1 to about 3. Especially suitable organic polyisocyanate include polymethylene polyphenyl isocyanate, methylenebis(phenyl isocyanate), toluene diisocyanates, or combinations thereof.

The preparation of polyurethane and/or polyisocyanurate foams using the polyol premix composition and an isocyanate may follow any of the methods well known in the art, see Saunders and Frisch, Volumes I and II Polyurethanes Chemistry and Technology, 1962, John Wiley and Sons, New York, N.Y. or Gum, Reese, Ulrich, Reaction Polymers, 1992, Oxford University Press, New York, N.Y. or Klempner and Sendijarevic, Polymeric Foams and Foam Technology, 2004, Hanser Gardner Publications, Cincinnati, OH, all of which are incorporated herein by reference. In general, polyurethane and/or polyisocyanurate foams are prepared by combining inter alia an isocyanate and a polyol premix composition. The produced foams are preferably closed cell foams which can be rigid or semi-rigid. Preferably the produced foams are rigid foams.

For the purposes of this invention, the isocyanate can be provided in combination with other components, such as certain silicone surfactants. The isocyanate can be combined with the blowing agent, but it is envisaged in this application, that the blowing agent will at least primarily comprise the polyol premix composition of the first aspect. The invention does however encompass the option wherein at least a portion of the blowing agent is combined with the isocyanate.

The polyurethane foam, polyisocyanurate foam or mixtures thereof are prepared by bringing together the isocyanate and polyol premix composition either by hand mix for small preparations and, preferably, machine mix continuous or discontinuous production techniques to form boards, blocks, slabs, laminates, pour-in-place panels and other items, spray applied foams, froths, and the like. Optionally, other ingredients such as colorants, auxiliary blowing agents, water, catalysts, and even other polyols can be added as a stream to the mix head or reaction site. Most conveniently, however, they are all, incorporated into the polyol premix composition as described above.

For the purposes of this invention, the polyurethane foam, polyisocyanurate foam or mixtures thereof are produced as continuous or discontinuous pour in place panels, boards or spray applied foams.

In particular, when the foam is provided as a board or a panel, the foam can be produced by pouring the foamable mixture between two facings of a panel, allowing the foam to rise to produce a “foam sandwich” which is cut to the desired length. The facings of the panel can be aluminium foil, roofing paper, metal, wood, etc. The resulting boards or panels can then be applied to an existing building envelope or used to form a building envelope. These panels can be produced by both a continuous or by a discontinuous process.

The second aspect of the invention provides a polyurethane foam, a polyisocyanurate foam or a mixture thereof produced from the method of the first aspect of the invention.

For the purposes of this invention, the foam contains from 1 to 15% by weight, preferably 2 to 13% by weight, more preferably 4 to 12 wt % of blowing agent. The blowing agent is as defined for the first aspect of the invention.

The polyurethane foam, polyisocyanurate foam or mixtures thereof produced can vary in density from about 0.5 pounds per cubic foot to about 60 pounds per cubic foot, preferably from about 1.0 to 20.0 pounds per cubic foot, and most preferably from about 1.5 to 6.0 pounds per cubic foot. The density obtained is a function of how much of the blowing agent or blowing agent mixture plus the amount of auxiliary blowing agent, such as water or other co-blowing agents is used to prepare the foam.

Among many uses, the foams of the present invention may be used to insulate buildings (e.g. building envelope) or any construction where energy management and/or insulation from temperature fluctuations on its exterior side are desirable. Such structures include any standard structure known in the art including, but not limited to those, manufactured from clay, wood, stone, metals, plastics, concrete, or the like, including, but not limited to homes, office buildings, or other structures residential, commercial, industrial, agricultural, or otherwise where energy efficiency and insulation may be desirable.

Thus, the second aspect of the invention relates to a board foam, a foam core panel or a spray foam produced by the method of the first aspect of the invention.

The foam of the second aspect of the invention provides a particular advantage of a reduction in lambda ageing overtime. In particular, the foam shows a reduction in lambda aging after 21 days aging at 70° C. More particularly, the foam has a delta lambda after 21 days aging at 70° C. of less than or equal to 6 mW/mK.

In particular, the foam shows a reduction in lambda aging after 21 days aging at 70° C. as measured under the “normality test” as set out in sections C.2 and C.3 of EN13165 (2010) for all foams except from spray foams, or as measured under the “normality test” as set out in sections C.2 or C.3 of EN14315 (2013) for spray foams. More particularly, the foam has a delta lambda after 21 days aging at 70° C. as measured less than or equal to 6 mW/mK under the “normality test” as set out in sections C.2 and C.3 of EN13165 (2010) for all foams except from spray foams, or as measured under the “normality test” as set out in sections C.2 or C.3 of EN14315 (2013) for spray foams.

The third aspect of the invention relates to a method of forming an article, for use in or as part of a building envelope, comprising a substrate and a foam on and/or attached to such substrate, wherein the method comprises forming said foam according to the method of the first aspect of the invention in association with an article to be installed in said building envelope and/or in association with a structural item or substrate, such as a wall, ceiling or roof component, that has already been installed in the building envelope.

The installing step may include pre-forming the foam, such as by forming a panel or insulation board, and installing said preformed foam on or in the building envelope. Alternatively or in addition the installing step may include forming the foam into or on a substrate or component of the building envelope as or after the envelope is built.

When the foam is provided as a spray applied foam, the foamable mixture can be applied to the building envelope (for example to the walls, roof, foundation, etc.), where the foam rises to provide in situ insulation. This foam can then be covered with a protective coating or an interior or exterior wall finishing.

All preferred features described for each aspect of the invention apply to all other aspects, mutatis mutandis.

### BRIEF DESCRIPTION ON OF THE DRAWINGS

FIG. 1 is a graphical representation of the dependence of delta lambda on TCPP dosage.

FIG. 2 is a graphical representation of the ageing comparison of TCPP and TEP, 70° C./21 days.

FIG. 3 is a graphical representation of the impact of RB-79 on lambda aging.

FIG. 4 is a graphical representation of the impact of combination of TCPP with RB-79 on initial lambda.

FIG. 5 is a graphical representation of the impact of combination of TCPP with RB-79 on lambda aging

FIG. 6 is a graphical representation of the impact of the FR combination of TCPP and RB-9170 on initial lambda

FIG. 7 is a graphical representation of the impact of the FR combination of TCPP and RB-9170 on lambda aging.

FIG. 8 is a graphical representation of the impact of TCPP on lambda aging of 1336mzz(Z)-blown foam (bottom line), compared with 1233zd(E) foam (top line).

### EXPERIMENTS

### Raw Materials:

Stepanpol PS 2352 (Stepan): Polyester polyol, Hydroxy number: 240mgKOH/g, functionality: 2
NIAX Silicone L-6900: a non-hydrolizable silicon surfactant from Momentive
Dabco K15: potassium-octoate in diethylene glycol from Air Products (now Evonik)
Polycat 8: N,N-dimethylcyclohexylamine from Air Products
Lupranate M 20 S: Polymeric isocyanate, 31.5% NCO, Functionality: 2.7 from BASF
Desmodur MDI 44V20L: Polymeric isocyanate, 31.5% NCO, Functionality: 2.7 from Covestro
Tris (1-chloro-2-propyl) phosphate (TCPP from Jiangsu Yoke
Trethyl phosphate (TEP) from Jiangsu Yoke
Saytex RB-79 (bromine-based reactive flame retardant, bromine content: 45%, hydroxy number: 210 mgKOH/g from Albermarle
Saytex RB-9170 bromine-based reactive flame retardant, bromine content: 43%, hydroxyl number: 170 mgKOH/g from Albermarle

Polyol blend: Blends were prepared by mixing the materials based on formulations below.

Foaming: The foam was made by hand mixing based on the formulation listed below. A mold (30 cm*30 cm*10 cm) was used.

Lambda value: The lambda value was recorded using the LaserComp FOX50 with a sample size of 20 cm*20 cm*2 cm.

### Determination of Average Lambda Value of Foam

Foam thermal conductivity is measured as per the requirements of EN13165:2008, Section 5.3.2 and EN14135-1:2013, Section 4.2.2. Both these standards require thermal conductivity testing by EN 12667 or, for thick products, EN12939. For the data presented in this document, the sample thickness did not exceed the testing capabilities of the testing apparatus, so EN 12667 was followed (See EN12939, Section 1 “Scope”). EN 12667 allows the use of two types of apparatus for measuring thermal conductivity, a guarded hot plate or a heat flow meter. For the data presented in this document, a heat flow meter, (Fox 314) was used. This apparatus conforms to EN12667, Annex D.

The thermal conductivity of a specimen is determined by measuring the heat flux, specimen thickness, and temperature difference across the specimen. In each component of the thermal conductivity equation FOX Instruments provide extremely precise readings, 0.6 mV resolution on integrating high output heat flux transducers, 0.001″ precision in thickness measurement, and 0.01° C. temperature control and resolution

For each individual test, a foam specimen with the dimensions of 300 mm×300 mm×20 mm was cut from a foam block after the foam was prepared and allowed to cure for 24 hours at room temperature. The foam specimen was placed in the Fox 314 heat flow meter set for a mean temperature of 10 C (hot plate temperature 15.6 C, cold plate temperature 4.4 C) and the thermal conductivity measured. This measurement is referred to as the initial lambda. After the test was completed, the sample was removed from the apparatus and placed in an oven set for 70 C. After 21 days of aging at 70 C, the sample was removed from the oven and allowed to set at room temperature for 16 hours. After this room temperature aging, for sample was again tested for thermal conductivity using the procedure described above. This is referred to as the aged lambda.

### Results and Discussion

1. Impact of Tris (1-Chloro-2-Propyl) Phosphate (TCPP) on Lambda Aging of 1233zd(E)-Blown Foam

To evaluate the impact of TCPP on lambda aging performance in a PIR foam, different dosages of TCPP were used in the formulation, as shown in Table 2. The foams have a free rise density of about 33 kg/m³. The molded foam has a core density of about 41 kg/m³.

TABLE 2
Formulation for PIR with different dosage of TCPP

| | |
|---|---|
| Raw materials | Parts |

| | | | | |
|---|---|---|---|---|
| Stepanpol PS 2352 | 100 | 100 | 100 | 100 |
| L6900 | 1.94 | 1.94 | 1.94 | 1.94 |
| Dabco K15 | 1.6 | 1.6 | 1.6 | 1.6 |
| Polycat 8 | 0.52 | 0.52 | 0.52 | 0.52 |
| Water | 0.8 | 0.8 | 0.8 | 0.8 |
| TCPP | 0 | 10 | 20 | 30 |

| | |
|---|---|
| trans-1-chloro-3,3,3- | 0.08 g blowing agent/g foam |

| | | | | |
|---|---|---|---|---|
| trifluoropropene | | | | |
| (1233zd(E)) | | | | |
| Desmodur 44V20L | 195 | 195 | 195 | 195 |

The effect of TCPP dosage (phpp) is set out in Table 3 below.

TABLE 3
Impact of TCPP on lambda aging

| TCPP dosage (phpp) | 0 | 10 | 20 | 30 |
|---|---|---|---|---|
| Initial Lambda (10° C., mW/mK) | 18.32 | 18.76 | 18.60 | 18.51 |
| Aged Lambda (10° C., mW/mK) | 23.48 | 24.14 | 24.38 | 24.81 |

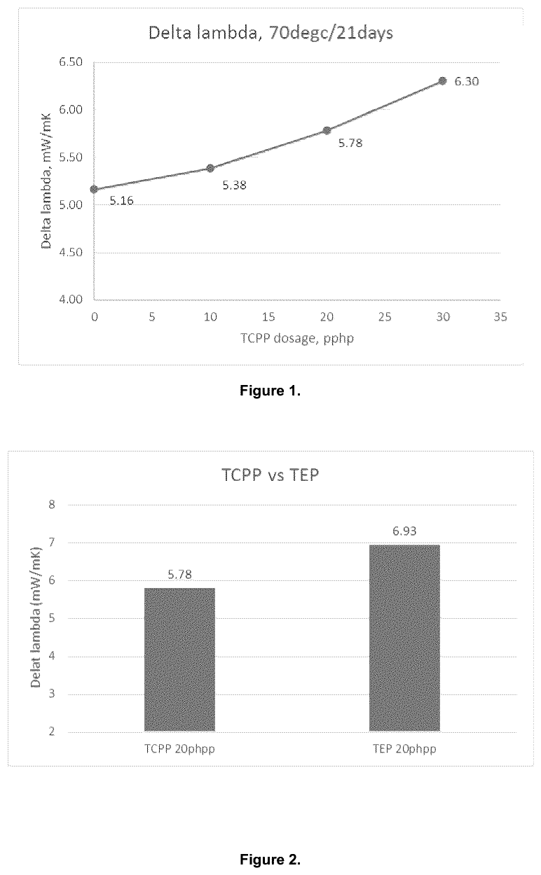

The initial Lambda values show that the PIR foam produced without TCPP showed a slightly better initial lambda value than those with TCP. After the foams were aged at 70° C. for 21 days, all lambda values increased, as expected. As illustrated in FIG. 1, the delta lambda increases as the TCPP dosage increases.

### 2. Tris (1-Chloro-2-Propyl) Phosphate (TCPP) Vs Triethyl Phosphate (TEP)

A PIR foam prepared from a polyol blend containing 20 parts of TEP (Table 4), has an initial lambda of 19.47 mW/mK. After this foam was aged at 70° C. for 21 days, the delta lambda obtained is 6.93 mW/mK a larger delta lambda than with TCPP (as illustrated in FIG. 2).

TABLE 4
Formulation for comparison of TCPP and TEP

| | |
|---|---|
| Raw Materials | Phpp |

| | | |
|---|---|---|
| Stepanpol PS 2352 | 100 | 100 |
| L6900 | 1.94 | 1.94 |
| Dabco K15 | 1.6 | 1.6 |
| Polycat 8 | 0.52 | 0.52 |
| Water | 0.8 | 0.8 |
| TCPP | 20 | |
| TEP | | 20 |

| | |
|---|---|
| trans-1-chloro-3,3,3- | 0.08 g blowing |
| trifluoropropene | agent/g foam |

| | | |
|---|---|---|
| (1233zd(E)) | | |
| Desmodur 44V20L | 195 | 195 |

### 3. TCPP vs Saytex RB-79

The impact of Saytex RB-79 (a hydroxy terminated ester of tetrabromophthalic anhydride with diethylene glycol and propylene glycol) on lambda aging was investigated. The initial lambda of the PIR foam with 10 phpp of RB-79 (Table 5) was 18.41 mW/mK (10° C.). After the foam was aged at 70° C. for 21 days, the lambda changed to 23.48 mW/mK. The delta lambda is only 5.08 mW/mK, better than the foam containing 10phpp TCPP (FIG. 3) and better than that without any flame retardant, 5.16 mW/mK. (see FIG. 1)

TABLE 5
Formulation for comparison of TCPP and RB79

| | |
|---|---|
| Raw Materials | Phpp |

| | | |
|---|---|---|
| Stepanpol PS 2352 | 100 | 100 |
| L6900 | 1.94 | 1.94 |
| Dabco K15 | 1.6 | 1.6 |
| Polycat 8 | 0.52 | 0.52 |
| Water | 0.8 | 0.8 |
| RB-79 | 10 | |
| TCPP | | 10 |

| | |
|---|---|
| trans-1-chloro-3,3,3- | 0.08 g blowing agent/g foam |

| | | |
|---|---|---|
| trifluoropropene | | |
| (1233zd(E)) | | |
| Desmodur 44V20L | 209 | 195 |

### 4. Impact of Combination of TCPP and RB-79 or RB-9170

To meet the EN13165 test, it was found that TCPP dosage has to be limited. In this case it may be desirable to adopt a secondary flame retardant in addition to TCPP. This secondary flame retardant may provide the required foam fire performance without negatively impact the lambda aging. Based on the above result, RB 79 or a similar brominated flame retardant, RB-9170 could be the potential candidate for this application to address the lambda aging issue.

Table 6 displays the formulation where a low dosage TCPP (10 phpp) was used in combination of RB-79 or RB-9170 at 3 phpp and 5 phpp respectively.

TABLE 6
Formulation for study the impact of
TCPP with secondary flame retardant

| | |
|---|---|
| Raw Materials | Phpp |

| Stepanpol PS 2352 | 100 | 100 | 100 | 100 | 100 |
|---|---|---|---|---|---|
| L6900 | 2 | 2 | 2 | 2 | 2 |
| K15 | 2 | 2 | 2 | 2 | 2 |
| PC8 | 0.8 | 0.8 | 0.8 | 0.8 | 0.8 |
| water | 0.8 | 0.8 | 0.8 | 0.8 | 0.8 |
| TCPP | 15 | 10 | 10 | 10 | 10 |
| RB-79 | | 3 | 5 | | |
| RB-9170 | | | | 3 | 5 |
| trans-1-chloro-3,3,3- | 0.1 g blowing agent/g foam | | | | |
| trifluoropropene | | | | | |
| (1233zd(E)) | | | | | |
| Lupranate M20 | 173 | 177 | 180 | 176 | 178 |

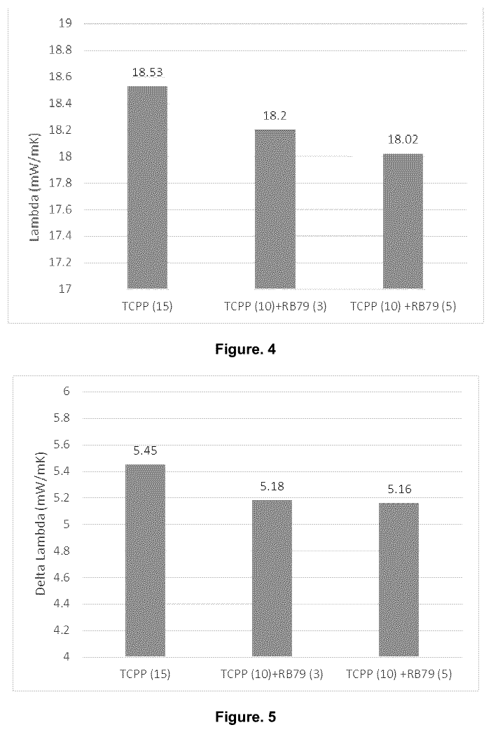

It was found that the addition of RB-79 or RB-9170 to TCPP not only lowers the initial lambda but also improves the lambda aging of foam (FIG. 4 and FIG. 5).

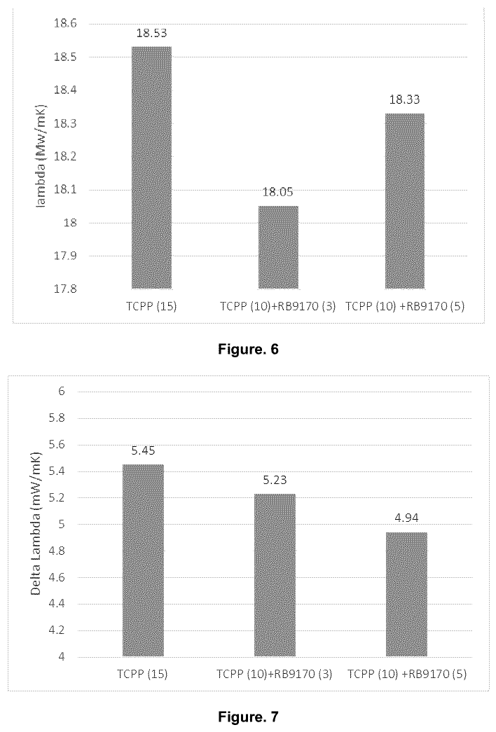

Reactive flame retardant RB-9170 has much lower viscosity than RB-79 (3000 cps vs 100000 cps). It should be favorable for the flowability in PIR manufacturing. This reactive flame retardant demonstrated similar effect as those of RB-79 when used in the combination with TCPP for both initial lambda and aged lambda (FIG. 6 and FIG. 7). It was noted that the initial lambda value was lower when the dosage of RB 9170 was at 3 phpp than that at 5phpp.

### 5. TCPP Impact on the Lambda Aging of 1336Mzz(Z)-Blown Foam

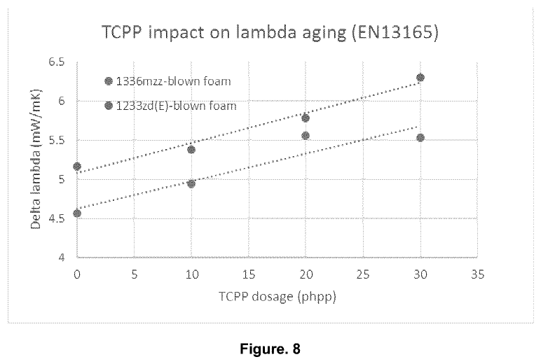

When 1336mzz(Z)-blown foams containing different dosage of TCPP (Table 7) was aged, the delta lambda increases as the TCPP dosage increases, as the case of 1233zd(E)-blown foam (FIG. 8). However, the delta lambda of 1336mzz(Z)-blown foam was always smaller than that of 1233zd(E)-blown foam at each dosage of TCPP.

TABLE 7
Formulation for study the impact of TCPP
on lambda aging of 1336mzz(Z)-blown foam

| Raw Materials | phpp | | | |
|---|---|---|---|---|
| Stepanpol PS 2352 | 100 | 100 | 100 | 100 |
| L6900 | 1.94 | 1.94 | 1.94 | 1.94 |
| Dabco K15 | 1.6 | 1.6 | 1.6 | 1.6 |
| Polycat 8 | 0.52 | 0.52 | 0.52 | 0.52 |
| Water | 0.8 | 0.8 | 0.8 | 0.8 |
| TCPP | 0 | 10 | 20 | 30 |
| 1336mzz(Z) | 0.1 g blowing agent/g foam | | | |
| Lupranate M20 | 194.8 | 194.8 | 194.8 | 194.8 |
| Density (pcf) | 2.33 | 2.33 | 2.33 | 2.38 |
| Initial lambda (10 C., mW/mK) | 20.05 | 20.21 | 19.74 | 19.7 |
| Aged lambda (10 C., mW/mK) | 24.62 | 25.15 | 25.3 | 25.23 |
| Delta lambda | 4.57 | 4.94 | 5.56 | 5.53 |

What is claimed is:

1. A method of reducing the lambda aging of a polyurethane foam, a polyisocyanurate foam or a mixture thereof, said method comprising producing said foam from a foamable composition comprising an isocyanate and a polyol premix composition;
wherein said polyol premix composition comprises a polyol or mixture of polyols, a blowing agent selected from the group consisting of 1,3,3,3-tetrafluoropropene (1234ze), 1,1,1,4,4,4-hexafluorobut-2-ene (1336mzzm) and/or 1-chloro-3,3,3-trifluoropropene (1233zd) and a flame retardant wherein the flame retardant comprises 25 phpp or less of a phosphate based flame retardant.

2. The method as claimed in claim 1 wherein the foam has a delta lambda less than or equal to 6 mW/mK after 21 days aging at 70° C.

3. The method of claim 1 wherein the flame retardant comprises 20 phpp or less of a phosphate based flame retardant.

4. The method of claim 1 wherein the flame retardant comprises 15 phpp or less of a phosphate based flame retardant.

5. The method of claim 1 wherein the flame retardant comprises 10 phpp or less of a phosphate based flame retardant.

6. The method of claim 1 wherein the flame retardant comprises 5 phpp or less of a phosphate based flame retardant.

7. The method of claim 1 wherein a phosphate based flame retardant is present and the phosphate based flame retardant is one or more of tris(2-chloroethyl)phosphate, tris(2-chloropropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl) aminomethylphosphonate, dimethyl methylphosphonate, tri(1,3-dichloroisopropyl)phosphate, diethyl-N, N-bis (2-hydroxyethyl) aminomethylphosphonate (Fyrol 6) tetra-kis-(2-chloroethyl)ethylene diphosphate, triethylphosphate and ammonium phosphate, more preferably tris(1-chloro-2-propyl) phosphate (TCPP), triethylphosphate (TEP) and diethyl-N, N-bis (2-hydroxyethyl) aminomethylphosphonate (Fyrol 6).

8. The method of claim 1, wherein the flame retardant further comprises a brominated reactive flame retardant.

9. The method of claim 8 wherein the brominated reactive flame retardant is Saytex RB-79 or Saytex RB-9170.

10. The method of claim 1 wherein the blowing agent comprises one or more of trans-1,3,3,3-tetrafluoropropene (1234ze(E)), cis-1,1,1,4,4,4-hexafluorobut-2-ene (1336mzzm(Z)) or trans-1-chloro-3,3,3-trifluoropropene (1233zd(E)).

11. The method of claim 1 wherein the blowing agent comprises trans-1-chloro-3,3,3-trifluoropropene (1233zd(E)).

12. The method of claim 10 wherein the blowing agent further comprises a co-blowing agent.

13. The method of claim 12 wherein the co-blowing agent is one or more selected from water, organic acids that produce CO₂ and/or CO, trans-1,2 dichloroethylene; methylal, methyl formate; 1,1,1,2-tetrafluoroethane (134a); 1,1,1,3,3-pentafluorobutane (365mfc); 1,1,1,2,3,3,3-heptafluoropropane (227ea), 1,1-difluoroethane (152a); 1,1,1,3,3-pentafluoropropane (245fa); butane; isobutane; normal pentane; isopentane; cyclopentane, or combinations thereof.

14. The method of claim 13 wherein the co-blowing agent is one or a combination of water and/or normal pentane, isopentane or cyclopentane.

15. The method of claim 1 wherein the blowing agent comprises trans-1-chloro-3,3,3-trifluoropropene (1233zd(E)) and water.

16. The method of claim 15 wherein the blowing agent consists essentially of trans-1-chloro-3,3,3-trifluoropropene (1233zd(E)) and water.

17. The method of claim 1 wherein the blowing agent has a Global Warming Potential of not greater than 150, preferably not greater than 100 and more preferably not greater than 75.

18. (canceled)

19. The method of claim 1 wherein the blowing agent component is present in the polyol premix composition in an amount of from about 1 wt. % to about 30 wt. %, by weight of the polyol premix composition.

20. (canceled)

21. The method of claim 1 wherein the polyol or mixture of polyols is present in the polyol premix composition in an amount of from about 50 wt % to about 95 wt. %, preferably from about 50 wt. % to about 85 wt. %, and more preferably from about 55 wt. % to about 80 wt. %, by weight of the polyol premix composition.

22. (canceled)

23. (canceled)

24. (canceled)

25. (canceled)

26. (canceled)

27. (canceled)

28. A method for forming an article, for use in or as part of a building envelope, comprising a substrate and a foam on and/or attached to such substrate, wherein the method comprises forming a foam by the method of claim 1 in association with an article to be installed in said building envelope and/or in association with a structural item or substrate, such as a wall, ceiling or roof component, that has already been installed in the building envelope.
